(19) United States
(12) Patent Application Publication
(10) Pub. No.: US 2014/0372865 A1
(43) Pub. Date: Dec. 18, 2014

(54) Interaction of Web Content with an Electronic Application Document

(71) Applicant: Microsoft Corporation, Redmond, WA (US)

(72) Inventors: Bradley Michael Corob, Kirkland, WA (US); Guy Lima, Seattle, WA (US); Silviu Ifrim, Sammamish, WA (US)

(21) Appl. No.: 13/917,199

(22) Filed: Jun. 13, 2013

(51) Int. Cl. G06F 17/22

(52) U.S. Cl. CPC G06F 17/2247
USPC 715/234

(57) ABSTRACT

Inserting web content into an electronic document such that the content layout and visual fidelity, as well as, functionality are preserved when the content is placed in the receiving document is provided. A selection of web content may be copied and pasted, dragged and dropped, sent to, shared with, referenced to, or otherwise deposited into an electronic document, such as a notes application document. When web content is placed in the receiving electronic document, a space in the document is set aside for receiving the HTML structured web content. The receiving application may call on required local or remote functionality for operating the received web content in a similar manner as it was operated by the web browser application from which it was received.

### BACKGROUND

With the advent of Internet-based web pages, an enormous amount of information is available to users of all types from business people to students to people of all ages and interests. With such plentiful information, it is often desirable to copy information from a web page into another electronic document, for example, an electronic notes application document, a word processing application document, a spreadsheet, a slide presentation, and the like. Unfortunately, because the structure and formatting of web pages (typically Hypertext Markup Language (HTML)) differs from that of most electronic documents, inserting web content into such documents provides an unsatisfactory result. Typically, when web content is inserted into such an electronic document, the layout and visual fidelity of the original content is lost, functionality associated with the content (e.g., operability of imbedded links, video content, audio content, etc.) is lost or degraded, and functionality of an application associated with the receiving document may not work on the inserted web content.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing for inserting web content into an electronic document such that the content layout and visual fidelity, as well as, functionality of the copied content is preserved when the content is placed into a receiving document. According to embodiments, a selection of web content may be inserted into an electronic document such as a notes application document according to a variety of methods, including copy/paste, drag/drop, web clipping, web content sharing (i.e., using a “send to” or “share” function for sending a portion of web content to the electronic document), or by providing a URL for the desired content to the application enabling the document to allow the application to retrieve the desired content. When the web content is placed in the receiving electronic document, a space is set aside for receiving the HTML structured web content.

When the content is placed in the receiving document, the receiving application may call on required local or remote functionality for operating the received web content in a similar manner as it was operated by the web browser application from which it was received. The content layout, visual fidelity and functionality of the content are preserved. Individual functional content items, such as embedded links, video files, audio files, and the like are operational, and the content may be moved, resized, scrolled and copied or moved to other documents. Importantly, functions of the receiving application may be used in association with the received content. For example, if the receiving application allows for highlighting or inking over inserted content, such functions may be performed on the received web content.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention.

FIG. 1 illustrates a system architecture for interaction of web content in an electronic application document.

FIG. 2 illustrates an electronic application document that has received a portion of web content from an Internet-based web page.

FIG. 3 illustrates an electronic application document that has received a portion of web content from an Internet-based web page.

FIG. 4 illustrates an electronic application document that has received a portion of web content from an Internet-based web page and illustrates movement of a received web content object from one location to another location in the document.

FIG. 5 is a flowchart of a method for interaction of web content with an electronic application document.

FIG. 6 is a block diagram illustrating example physical components of a computing device with which embodiments of the invention may be practiced.

FIGS. 7A and 7B are simplified block diagrams of a mobile computing device with which embodiments of the present invention may be practiced.

FIG. 8 is a simplified block diagram of a distributed computing system in which embodiments of the present invention may be practiced.

### DETAILED DESCRIPTION

As briefly described above, embodiments of the present invention are directed to interaction of web content with one or more electronic application documents. The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described may be modified by substituting, reordering, or adding stages to the disclosed methods. Accordingly, the following detailed description does not limit the invention but, instead, the proper scope of the invention is defined by the appended claims.

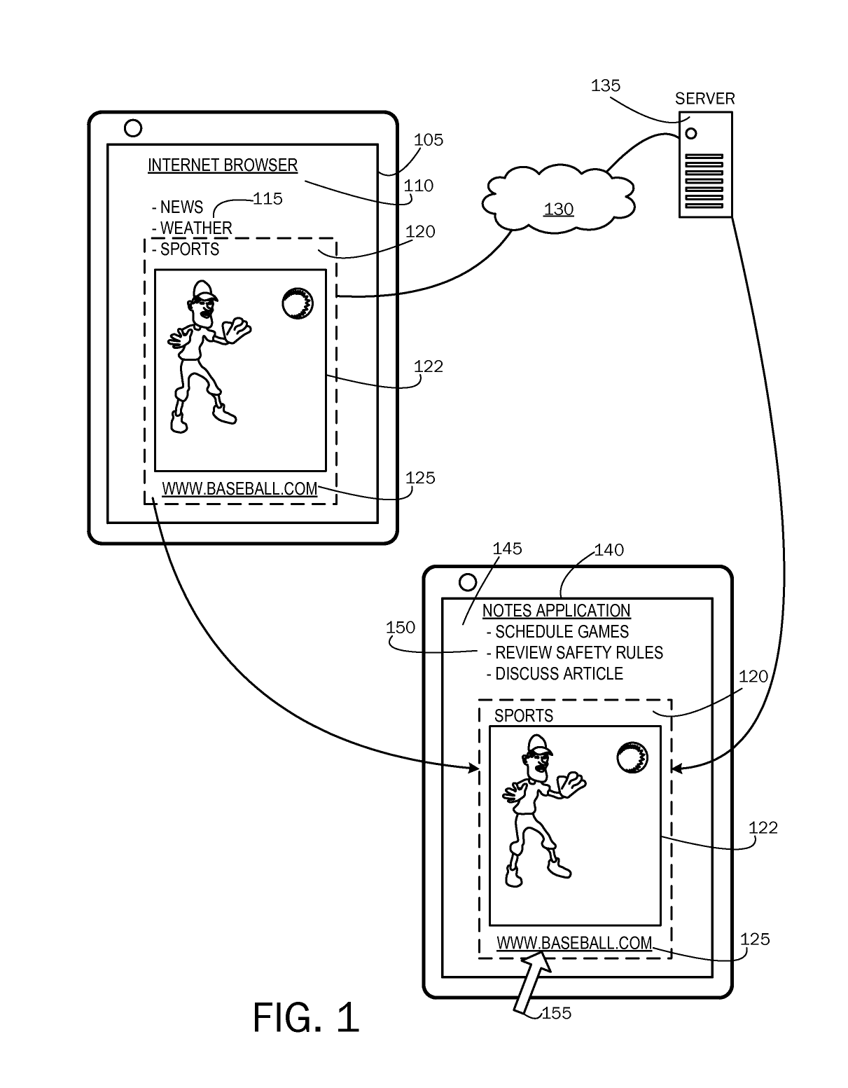

Referring now to FIG. 1, a system architecture for interaction of web content with one or more electronic application documents is illustrated. Two electronic computing devices 105 are illustrated with which embodiments of the present invention may be practiced, as described herein. The electronic devices 105 are illustrated as tablet-style computing devices. As should be appreciated, the tablet-style computing devices 105 are for purposes of example and illustration only and are not limiting of the various types of computing devices with which embodiments may be practiced. For example, the computing devices 105 may be in the form of smart telephones, laptop computers, desktop computers, slate computers, or any other computing device operative for allowing interaction of web content with one or more electronic application documents, as described herein. Input to such electronic devices may be enabled according to a variety of different methods including keyboard entry, mouse entry, touch entry, gesture entry, voice command entry, swipe entry, and the like.

As should be appreciated, the illustration of two computing devices 105 is illustrative of one or more computing devices 105. That is, embodiments of the invention described herein, including examples of operation of embodiments of the invention described herein, may operate between two or more different computing devices 105, or may operate on a single computing device 105 where web content is passed from an Internet browser application 110 to one or more other electronic application documents on a single computing device 105 or on multiple computing devices 105.

The distributed computing network 130 is illustrative of a network (e.g., Internet, intranet) over which information and data of all types may be transmitted between the computing devices 105 and one or more other devices, including the server 135 at which information may be stored and from which information may be retrieved. Similarly, the server 135 may be a remote location from which functionality associated with embodiments of the present invention may be retrieved for use on one of the local computing devices 105. The combination of the local computing devices 105 with the distributed computing network 130 and the back end server 135 may form a collaborative “cloud” type computing environment with which information may be passed between computing devices and to/from computing devices to remote storage and functionality devices in a distributed computing environment.

Referring to the computing device 105 illustrated in the upper left hand corner of FIG. 1, an Internet browser application 110 is illustrated as displayed on a display surface of the computing device 105. The Internet browser application 110 is illustrative of any suitable software application operative for allowing a user to access, review, consume and otherwise interact with electronic content provided via one or more Internet-based or intranet-based web pages. An example web page 115 is illustrated as being displayed by the Internet browser application 110. The example web page is illustrative of a common news organization web page having one or more links for allowing a user to view such interesting sections as news, weather, sports and the like. As should be appreciated, the example web page 115 is for purposes of illustration only and is not limiting of the vast numbers of web pages that may be displayed by the Internet browser application 110.

Referring to the computing device 105 illustrated in the lower right corner of FIG. 1, a notes application 145 is illustrated as opened on the computing device 105, and an example notes document 150 is illustrated as displayed in a user interface of the example notes application 145 for allowing a user to enter, edit, display, print, or otherwise interact with notes and other information of interest to the user. As should be appreciated, the notes application 145 is for purposes of example and illustration only and is not limiting of other types of electronic software applications and associated documents that may be utilized in accordance with embodiments of the present invention, for example, word processing applications, spreadsheet applications, desktop publishing applications, calendaring applications, electronic mail applications, tasks applications and the like.

According to embodiments of the present invention, a portion of content from a given web page enabled by and displayed by the Internet browser application 110 may be inserted into an electronic application document enabled by a different software application such that the inserted portion of web content may be placed in an electronic document of the other software application to allow use of the web content in the receiving electronic document according to the functionality of the receiving electronic software application. For example, as illustrated in FIG. 1, a user has retrieved a portion of web content from the example news service web page displayed by the Internet browser application 110, and the user has inserted the portion into a notes application document 150 with which the user is preparing notes about a given topic.

For example, the user may be preparing a notes document 150 using his/her notes application 145 to generate an agenda for a youth sports team the user is coaching, and the user may decide that a portion of web content provided by the example news service via the Internet browser 110 would be helpful if pasted into his/her notes so that when the user presents his/her agenda to his youth sports team, he/she can relate to or read or otherwise utilize a portion of web content placed in his/her notes from the Internet-based news service web page. As should be appreciated, the foregoing is but a simple example of the vast amounts of web content that may be placed in an electronic application document for subsequent use in a receiving document.

According to embodiments, inserting of a portion of web content from the Internet browser application 110 into a second or different electronic software application document 150 may be performed according to a variety of suitable operations. As briefly described above, suitable methods of obtaining a portion of web content for insertion into an application document may be include copy/paste, drag/drop, web clipping, web content sharing (i.e., using a “send to” or “share” function for sending a portion of web content to the electronic document), or by providing a URL for the desired content to the application enabling the document to allow the application to retrieve the desired content.

According to embodiment copy/paste method, content from the Internet browser application 110 may be copied and pasted from the Internet browser application 110 to the receiving application document 150 according to well known copy/paste operations. That is, a range of content is selected by a user from the providing application document (e.g., Internet browser enabled web page 115), followed by pasting of the range of content to the receiving document 150. In such a case, the receiving application in association with an operating system of the receiving computing device 105 designates a receiving range in the receiving document for placement of the copied and pasted content. As is understood by those skilled in the art, the pasted content may be inserted into the receiving document such that content around the pasted content may be moved out beyond a range required for bounding the received content such that the received content is placed “in line” with other content contained in the receiving document, or the pasted content may be placed in an overlay window or pane sufficient for bounding the received content, where the overlay is displayed on top of other content contained in the receiving document such that content being covered by the overlay is not visible when the overlaying content is in place. According to a drag/drop method, a well-known function of selecting a portion of content from a web page, following by dragging the selection onto the receiving document and dropping the selection at a desired point may be utilized for inserting the selected web content into the receiving document.

A web clipping application may be utilized for obtaining a portion of content from a web page, followed by inserting the web content into the receiving document. A web clipping application may allow for content selection other than selecting a range or region first followed by cutting, dragging or moving the selected range or region. That is, a web clipping application may allow for other types of selection, such as specified text ranges or content areas comprised of pixel ranges (e.g., x by y pixels) regardless of the text/images/other content contained in the range. A web clipping application may operate as a standalone application or may function as a module of a web browser application or as a module of a given software application obtaining the portion of web content, for example, a notes application.

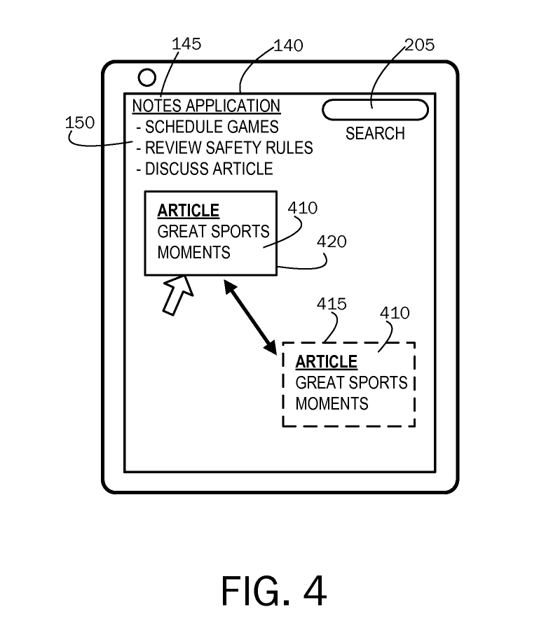

Other suitable means for inserting a portion of web content from an Internet browser enabled web page to a receiving document include using a “send to” function of the Internet browser application or other application enabling the content for sending a portion of selected web content to the receiving application document 150. According to a “send to” implementation, a portion of web content is selected by a user followed by selection of a “send to” function of the Internet browser or other application, which, in turn, sends a copy of content bounded by the user's selection from the web page to the receiving application document 150. In such a case, the content sent from the providing application to the receiving application may be inserted into the receiving document at any available location in the receiving document, and the user may be required to then move the received web content in the receiving document, as desired, and as described below with reference to FIG. 4.

In the case of a sharing function, a portion or all of a web page may be shared with another application from a web browser application responsible for hosting the web content or from another application that enables the desired web content in an application. For example, a portion of web content may be shared from a web browser application by sending the content to the requesting application or by sending a URL (uniform resource locator) for the desired content to the requesting application for allowing the requesting application to obtain the desired content via the URL. As well known to those skilled in the art, a number of functions are available to electronic mail applications, social media applications, and the like allow for sharing a given piece of content, including web content, with another user, and such functions may be used for receiving such a piece of content for inserting the content into a receiving document according to embodiments of the present invention.

Likewise, one application utilizing the desired web content, for example, a notes application, word processing application, slide presentation application and the like, may share a piece of web content with another such application for inserting the content into a document enabled by the receiving application. In such a case, the receiving application may provide and entry point for receiving web content from another document of the same application or from a document enabled by a different application altogether.

As well understood, typical web content displayed by an Internet browser application 110 is formatted and structured according to Hypertext Markup Language (HTML). As understood by those skilled in the art, HTML allows for a series of tags for applying structure and meaning to content, including text, images, video content, audio content, colors, and the like associated with the HTML tags such that any application operative for receiving, consuming, understanding, and utilizing HTML structured content may receive, display, and operate the HTML structured content.

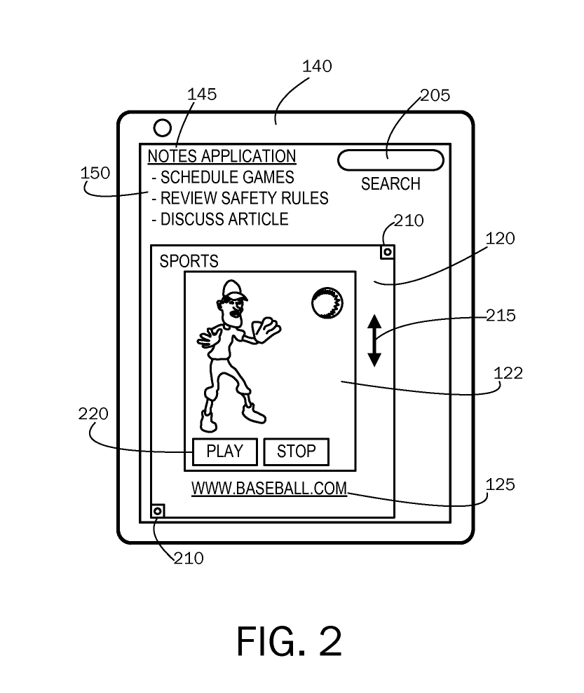

According to embodiments of the present invention, when a portion of web content, whether a small portion, or all content of a given web page is received from an Internet browser web page into a second software application document 150, for example, the example notes application document 150, illustrated in FIG. 1, the HTML structuring/formatting, along with all the layout, visual fidelity, contents, and operating functionality associated with the received portion of web content is preserved with the portion of web content and is enabled in the receiving application document, as described below with reference to FIGS. 2 through 5.

According to one embodiment, the receiving application 145 is equipped with sufficient computer executable instructions for understanding and operating a portion of web content (e.g., a portion of HTML formatted/structured content) placed in a document enabled by the receiving application. Alternatively, functionality for receiving, consuming and operating a portion of web content may be maintained at a remote computing system 135 that may be called on by the receiving application 145 for allowing the receiving application to utilize the received web content, as described herein. According to yet another embodiment, an operating system of the computing device 105 on which the receiving application 145 is operated may provide necessary functionality for allowing the received web content to be consumed and utilized in the receiving document 150 in the same manner in which it was utilized in the providing Internet-browser web page. That is, according to embodiments of the present invention, whether received web content is placed “inline” in an area sufficient for bounding the received web content, or whether the received web content is placed in an overlay window or pane placed on top of other content contained in the receiving document, the received web content may function in the receiving document with all functional capabilities and aspects available to the received web content as it had in the providing web page according to the functionality of the Internet browser application from which it was received.

Referring still to FIG. 1, a portion of web content 120 may be received from a given web page to a receiving application document 150 on a local level, where the portion of web content is moved from the Internet browser application web page to the receiving application document at a client level on a single computing device 105. Alternatively, the copied portion of web content may be stored at a remote “cloud” based storage/computing system 135, and the copied portion of web content may be pushed to or pulled to the receiving application document 150 at the command of the receiving application 145. According to this server implementation, the web content is inserted into the document at the server 135, and the document is retrieved by a client level application/document for use at the client level. Alternatively, the web content may be inserted into a receiving document at the server 135, and the client level application may serve as a thin client for reading, displaying and allowing interaction with the server-based implementation.

In either case, processes may be performed on the web content either at the client level or at the server level for transforming the web content before it is inserted into the receiving document. For example, a standalone module or a module integrated into the receiving application either at the server or at the client level may transform the content into a more useful form. For example, advertisements contained in the web content may be stripped, the font size of the content may be changed, the content item may be resized, processing-heavy images may be stripped, and the like. As should be appreciated, a menu of content transformation functions may be provided to the requesting user and/or certain functions (e.g., advertisement removal) may be performed automatically on demand.

Referring now to FIG. 2, a portion of web content 120 is illustrated as being inserted into a document 150 of an example notes application 145 where all of which is displayed on a display surface of a computing device 105. As described above, according to embodiments of the present invention, when a portion of web content 120 is inserted into an electronic application document 150, the layout and visual fidelity of the portion of the web content is preserved in the receiving document such that the portion of web content looks like it did in the providing web page. For example, referring to the example web content 120, the text of the portion, images 120 contained in the portion, links 125 contained in the portion, along with colors applied to the text, images, links, or other content contained in the portion are all preserved according to the same layout and visual fidelity as was maintained in the providing Internet browser web page. That is, text size and font, text location in the portion, image size and coloring, locations of links, background colors or designs, and the like are preserved in the receiving document such that the received web content does not differ from the layout and visual fidelity/presentation that was provided for the web content in the providing web page.

One or more resizing handles 210 may be provided for the web content to allow the web content inserted into the receiving document to be resized by dragging one or more of the handles 210 outward or inward to resize the content as desired. According to embodiments, if the content is resized, layout and visual fidelity are continued to be maintained, wherein the sizes of content items, for example, text strings, images, links, and the like are accordingly resized to maintain proportionality and visual fidelity of items contained in the web content such that, even in a resized configuration, the web content received into document 150 maintains the same layout and visual fidelity as it had in the providing web page.

Alternatively, the resizing handles 210 may operate for causing a re-flowing of the content contained in the inserted web content item. As known to those skilled in the art, HTML may use a flow-based model where the geometry of each item in a displayed portion, including text, images, graphics and the like is computed, and the layout for the displayed portion is determined prior to display. According to embodiments, the resizing handles 210 may be used for causing a re-flow of a received web content item so that the content fits the length and width of a constraining or bounded display area (i.e., similar to a process involved in resizing a web browser window). In such a case, resizing may result in a change of the layout of the received content owing to a re-flowing of the items contained in the received web content item.

According to embodiments, after a given portion of web content is placed in a receiving application document 150, functionality available to the web content in the providing Internet web page is preserved in the web content after it is placed in the receiving document 150. For example, links 125 contained in the received web content remain active such that selection of a link 125 contained in the web content received in the application document 150 is an active link. According to one embodiment, selection of such a link 125 may cause an immediate launching of an instance of the Internet browser application 110 for allowing the user to navigate to a web page associated with the link. According to another embodiment, an instance of an Internet browser application 110 may be launched and provided in the space consumed by the received web content such that a live instance of the Internet browser 110 operates in the area bounding the received portion of web content such that the browser application operates as an application within an application to allow the user to navigate to the desired link. In addition to following an active link to associated web content, a link may be provided in the received web content for allowing a user to navigate back to a source of the received web content.

According to one embodiment, as the source of the web content is changed, revised, or otherwise modified, the web content received in the document 150 is preserved as it was originally placed in the receiving document. That is, as content of the received web content is altered at the content source, those alterations or revisions will not be published through to the portion of web content that has been inserted into and received by the receiving document. As should be appreciated, if the portion of web content received in a given application document is significant to the requesting and receiving user, automatic changes or revisions to that content may produce an undesirable effect where the content that was important to the requesting and receiving user is no longer available in his/her receiving document. Alternatively, embodiments of the present invention may provide for an automatic or periodic refresh of the received content where such an automatic or periodic refresh is desired. For example, if a user inserts a portion of web content associated with sports scores into a notes application document, word processing application document, spreadsheet application document, or the like where it would be advantageous to the user to have the received content updated when sports scores change as reflected in the received web content, then having an automatic or periodic refresh of the content in the receiving document would be advantageous.

Referring still to FIG. 2, a scrolling element 215 is shown for illustrating that the received web content may be scrolled within the area bounding the received web content. As should be appreciated, the scrolling element 215 is for purposes of example only as no scroll bar or other scroll button/control may be required for allowing a movement or scrolling of the web content displayed in the receiving document to be scrolled up, down, right, or left. According to this embodiment, a portion of web content may be inserted from a providing web page that exceeds the display space provided by the receiving application, and an area bounding the received web content may be set at a desired or maximum size, such that the web content received in the document may not be completely displayed within the designated display area. While a portion of the received web content may be visible in the area in which the received web content is displayed, not all of the received content may be visible at any given time. Thus, according to embodiments, the user may scroll the web content within the display area for reviewing those portions of the web content that are not presently in view.

Referring still to FIG. 2, a video and/or audio presentation object 122 is illustrated in the received web content. Controls 220 are illustrated for playing, stopping, rewinding, fast forwarding, and the like associated with the received video content. According to embodiments, a video content may be utilized (i.e., played) via the presentation object 122 in the receiving application document in the same manner in which the video content item may be utilized in the providing web page. As described above with reference to FIG. 1, the functionality for utilizing the embedded content item may be called on by the application 145 as a client-based functionality, operating system-based functionality, or the functionality may be called on from a remote computing system 135 via a distributed network 130. Just as video content may be utilized in the received web content and the receiving document, so may audio content be played via the audio presentation object 122. Other dynamic objects such as animations may likewise be presented in the pasted web content object 120.

According to an embodiment, if a functionality is contained in the received web content item, for example, animations, video content items, audio files, and the like that operate in the original providing web page according to a programming script, the programming script may be received in the receiving document along with the received web content item so that the same functionality will be available in the received application document. As described above, the functionality of the associated programming script may be called by the receiving application either locally or remotely for providing the associated functionality in the receiving document. Alternatively, if the programming script is not available in the receiving application, or if the receiving application may not access the appropriate functionality for operating the programming script, then any item associated with such a programming script may be shown as a static visual display, but the associated functionality, for example, playing of an animation, video content item, audio file, or the like may not be available.

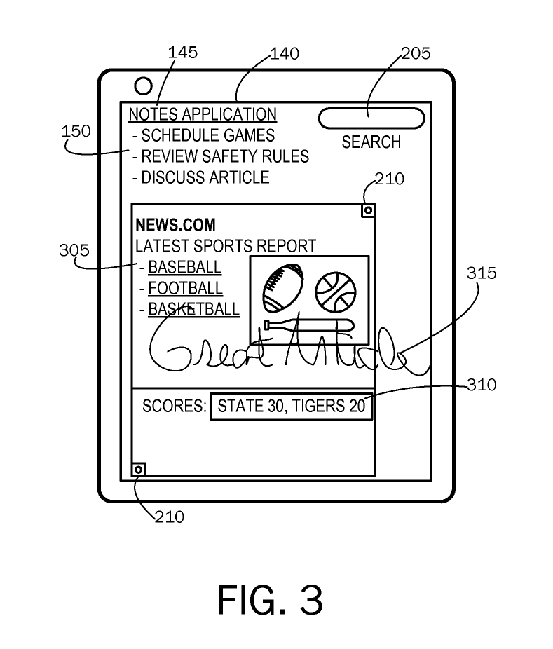

Referring now to FIG. 3, according to embodiments, functionalities of the receiving software application 145 may be utilized in association with web content received in an application document 150. For example, if the application 145 includes a search function 205, for allowing a searching for one or more text items contained in the application document 150, the search function 205 may also be used for searching for one or more text items contained in the received web content. For example, if a user types the word “baseball” into the search field of the search function 205, the word “baseball” may be located anywhere in the document 150 including in the received web content. As should be appreciated, because text content contained in the received web content is structured according to HTML, then because the receiving application is operative to understand and consume the received HTML content, as described above, then the receiving application can locate a searched term or terms contained within the tagged HTML content contained in the received web content.

Referring still to FIG. 3, a highlighting 310 is illustrated over a portion of text contained in the received web content 305. Thus, if the receiving application allows for highlighting of text or images contained in an enabled document, then highlighting may also be performed on text or images contained in a received web content item. Likewise, if an inking function is provided that allows a user to perform free flowing inking, such as handwriting, over content contained in the application document, such inking functions are available on text, images or other content contained in the received web content item. An example inking notation 315 is illustrated in FIG. 3.

According to an embodiment, application of functionality, for example, highlighting, inking, or pasting other content on top of a received web content item may be accomplished by displaying the results of such functionality on an overlay that is placed over the received web content item. For example, if a user desires to highlight 310 a term or image contained in the received web content item, the highlighting may be performed by use of a touch gesture such as a finger swipe, a stylus touch/swipe, or one or more keyboard and/or mousing operations. When the highlighting is performed, the application 145 may display a transparent overlay over the received web content item, and the received highlighting may be displayed on the overlay which is, in turn, placed over the received web content item at the appropriate location. As should be appreciated, an inking operation for placing one or more inking notations 315 onto the received web content item may be performed in the same manner. Thus, the user may interact with the received web content item in the same manner as he/she interacts with other content items contained in the receiving application document according to the functionality of the receiving application.

Referring now to FIG. 4, according to embodiments, a web content item or object received in an application document 150 may be moved from one location in the receiving document to another location in the receiving document. As illustrated in FIG. 4, the example article content item 410 has been moved from a first location 415 (illustrated as bounded by a dotted line) in the lower right hand corner of the document 150 to a second location 420 to the left and above the original location. As should be appreciated, when a received web content item or object is moved from one location to another in a receiving application document, movement of the web content item to the new location is performed in the same manner as placing the web content item in the application document, wherein the web content item is either inserted “inline” with other content items, for example, text strings, images, and the like contained in the new location, or wherein the moved web content item is displayed in an overlay over other content items contained in the location to which the web content item is moved. Once the web content item is moved from a first location to a second location, all available functionality for use in association with the web content item 410 is available, as described above with reference to FIGS. 1-3.

In addition, according to embodiments, a web content item received in an application document 150, as described herein, may be copied to, dragged to, or sent to another application document apart from the present application document in which it has been received. For example, if the web content item 410 illustrated in FIG. 4 is presently received in a notes application document 150, and the user desires to insert the same web content item to another document he/she is editing, for example, a word processing application document, the user may copy, drag, or send the desired web content item 410 from the example notes application document to the other document, as desired. When the web content item is copied to, dragged to, or otherwise sent to the other document, it will be received in the other document, and it will have all the availability functionalities and benefits in the other document as it does in the presently received application document, as described above with reference to FIGS. 1-3.

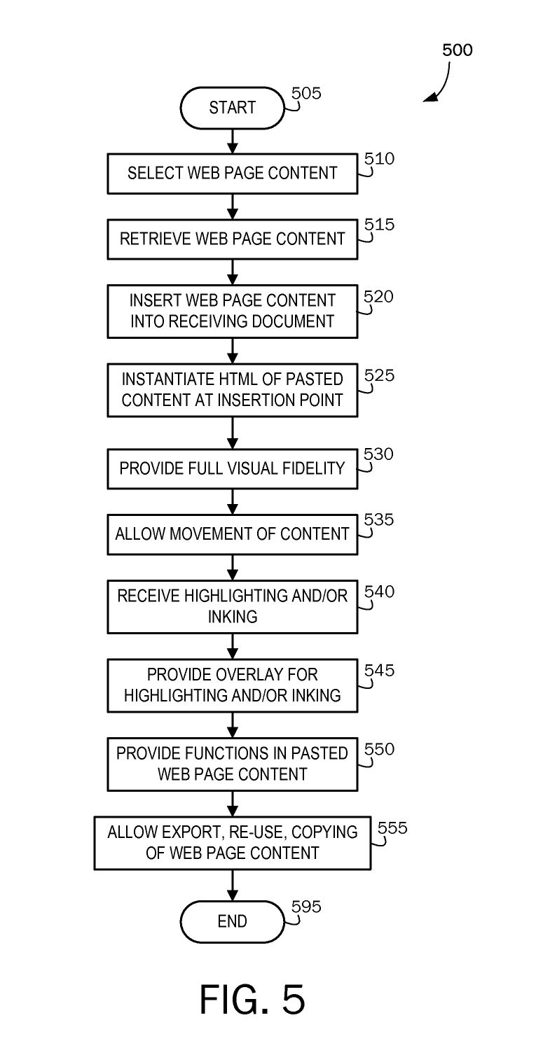

Having described a system architecture and various aspects of the embodiments of the present invention above with reference to FIG. 1 through 4, FIG. 5 is a flowchart of a method for interaction of web content with an electronic application document. The method 500 begins at start operation 505 and proceeds to operation 510 where a portion of web content is selected by a user for inserting into a desired application document, as illustrated and described above with reference to FIG. 1. For example, a user may wish to insert an interesting article he/she finds on a given Internet web page into a notes application document, word processing document, spreadsheet, slide presentation document, and the like for use and enjoyment in association with the receiving document.

At operation 515, the desired web content selection is obtained from the web page, and at operation 520 the web content is inserted into the receiving document 150, as illustrated in FIG. 1. As described above with reference to FIG. 1, suitable methods of obtaining a portion of web content for insertion into an application document may be include copy/paste, drag/drop, web clipping, web content sharing (i.e., using a “send to” or “share” function for sending a portion of web content to the electronic document), or by providing a URL for the desired content to the application enabling the document to allow the application to retrieve the desired content. At operation 525, the HTML structured content is instantiated into a bounded area, for example, a window or pane sized appropriately for receiving the HTML structured/formatted content received from the web page.

At operation 530, layout and visual fidelity of the received web content is presented in the receiving document in the same manner as the received web content was presented in the providing web page, as described above with reference to FIG. 2. At operation 535, if the user desires to move the received web content item or object to a different location in his/her document, the user may do so, as described above with reference to FIG. 4, and the received web content item will have the same layout, visual fidelity, and functionality in the new location.

At operation 540, highlighting, inking or other similar application functionality may be performed or requested by the user in association with the received web content item, and those functions will be enabled, as described above with reference to FIG. 3. At operation 545, if the user has performed highlighting or inking operations over text, images, or other content provided in the received web content item, those functions may be provided in an overlay placed over the appropriate portion of the displayed web content item, as illustrated and described with reference to FIG. 3. At operation 550, any other functions available to the receiving application 145, for example, text searching, spell checking, and the like, may be performed on the received and displayed web content item, as described above with reference to FIG. 3.

At operation 555, export, reuse, copying, dragging, sending, or otherwise passing the received and displayed web content item from the receiving document to another receiving document may be performed, as described above with reference to FIG. 4. The method 500 ends at operation 595.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

As described above with reference to FIG. 1, while embodiments of the present invention may operate via a client level application for receiving and inserting web content into a receiving document, other embodiments may include provision of web content functionality at a server side where web content may be manipulated and edited (for example, stripped of unwanted items like advertisements), where content may be augmented by adding to the content or updating the content (for example, when the underlying web page is changed), where content may be re-flowed or reformatted for better consumption in the receiving document, and the like. That is, embodiments of the present invention are equally suitable for use in association with endpoint applications for receiving and inserting desired web content and for use in association with server side applications for enabling a variety of useful functions for the received and inserted web content.

The embodiments and functionalities described herein may operate via a multitude of client side and server side computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

Use of embodiments and functionalities via server side computing systems may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

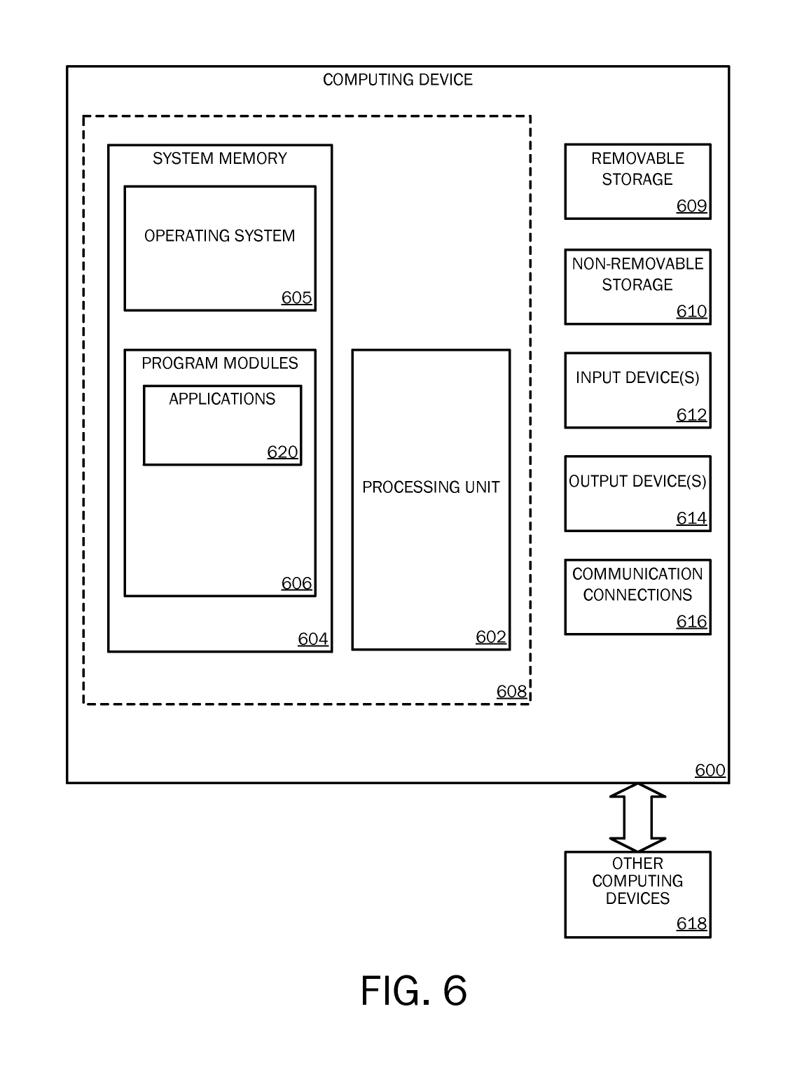

FIGS. 6-8 and the associated descriptions provide a discussion of a variety of operating environments in which embodiments of the invention may be practiced. However, the devices and systems illustrated and discussed with respect to FIGS. 6-8 are for purposes of example and illustration and are not limiting of a vast number of computing device configurations that may be utilized for practicing embodiments of the invention, described herein.

FIG. 6 is a block diagram illustrating physical components (i.e., hardware) of a computing device 600 with which embodiments of the invention may be practiced. The computing device components described below may be suitable for the computing devices 105 described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running a variety of applications 620. The operating system 605, for example, may be suitable for controlling the operation of the computing device 600. Furthermore, embodiments of the invention may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including, but not limited to, one or more of the stages of the method 500 illustrated in FIG. 5. Other program modules that may be used in accordance with embodiments of the present invention may include applications, such as, notes applications 145, Internet browser application 110, electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to use of web content may be operated via application-specific logic integrated with other components of the computing device 600 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 600 may also have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600.

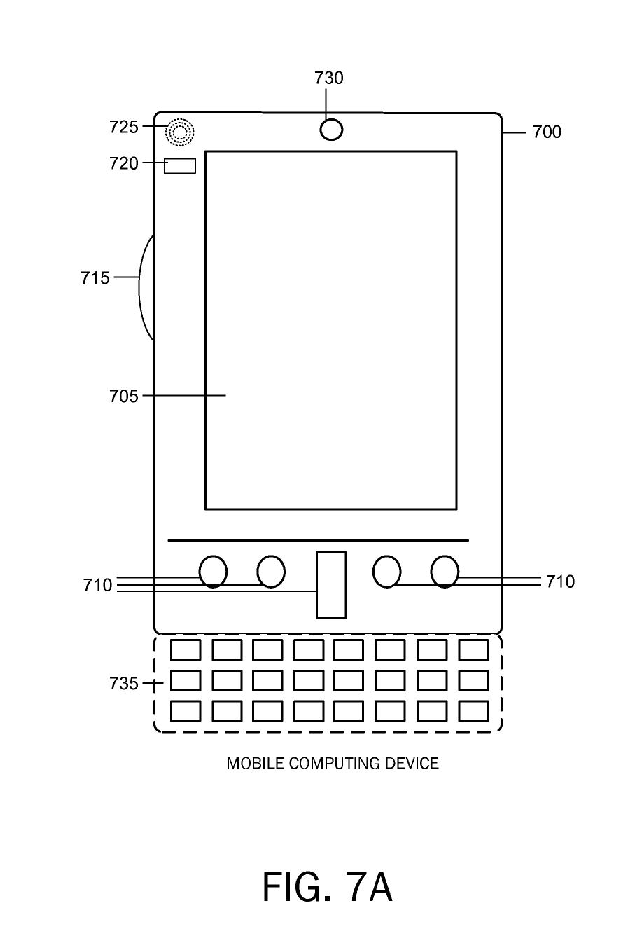

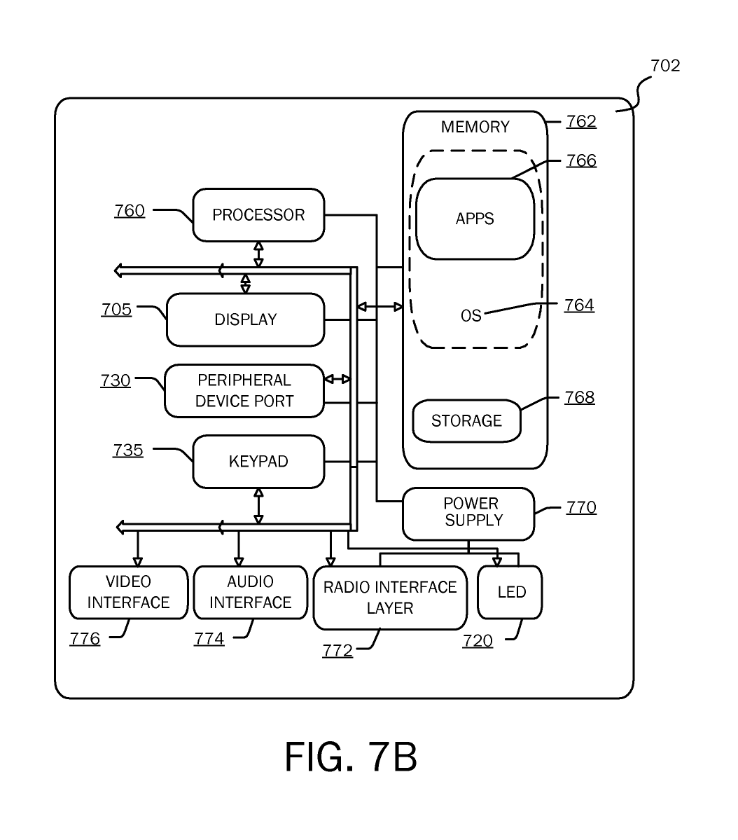

FIGS. 7A and 7B illustrate a mobile computing device 700, for example, a mobile telephone, a smart phone, a tablet-style personal computer 105, a laptop computer, and the like, with which embodiments of the invention may be practiced. With reference to FIG. 7A, one embodiment of a mobile computing device 700 for implementing the embodiments is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative embodiments, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some embodiments, the mobile computing device 700 incorporates a vibration transducer for providing the user with tactile feedback. In yet another embodiment, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one embodiment of a mobile computing device. That is, the mobile computing device 700 can incorporate a system (i.e., an architecture) 702 to implement some embodiments. In one embodiment, the system 702 is implemented as a “smart phone” capable of running one or more applications (e.g., browser, e-mail, calendaring, contact managers, messaging clients, games, and media clients/players). In some embodiments, the system 702 is integrated as a computing device, such as an integrated personal digital assistant (PDA) and wireless phone.

One or more application programs may be loaded into the memory 762 and run on or in association with the operating system 764. Examples of the application programs include phone dialer applications, e-mail applications, personal information management (PIM) applications, word processing applications, spreadsheet applications, Internet browser applications, notes applications, messaging applications, and so forth. The system 702 also includes a non-volatile storage area 768 within the memory 762. The non-volatile storage area 768 may be used to store persistent information that should not be lost if the system 702 is powered down. The application programs may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 120 via the operating system 764, and vice versa.

The visual indicator 720 may be used to provide visual notifications and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present invention, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

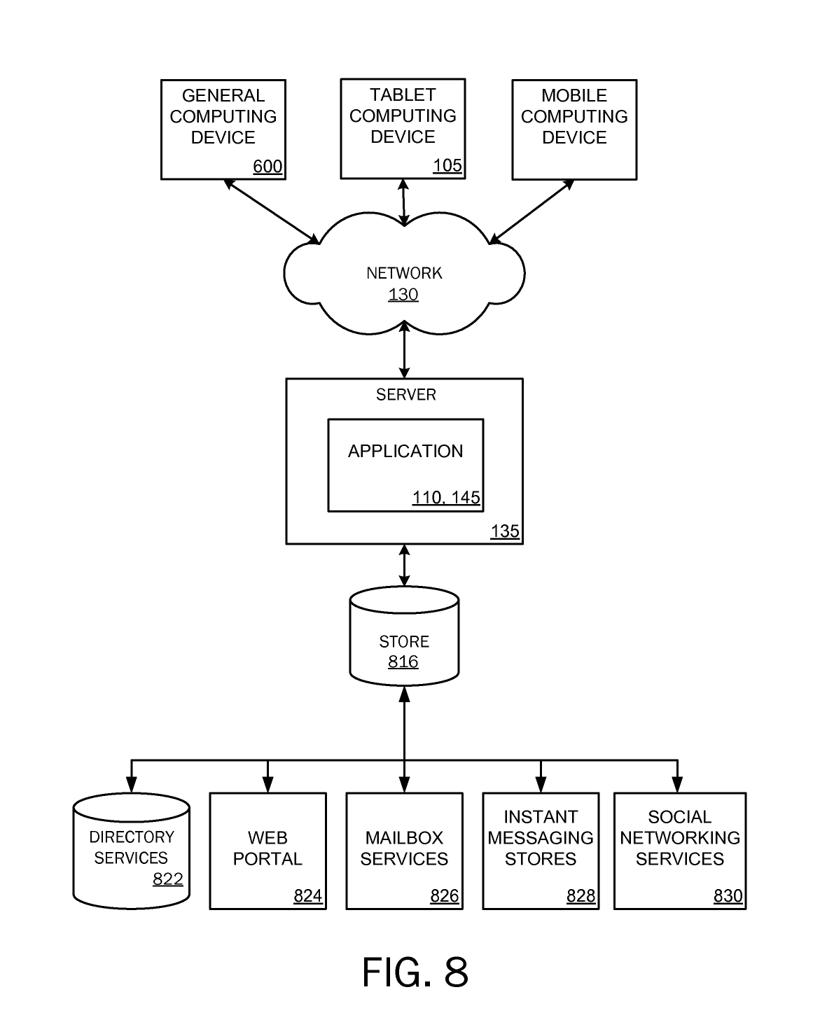

FIG. 8 illustrates one embodiment of the architecture of a system for providing web content utilization, as described above. Content developed, interacted with, or edited in association with embodiments of the invention may be stored in different communication channels or other storage types. For example, various documents and stored content items (including web content) may be stored using a directory service 822, a web portal 824, a mailbox service 826, an instant messaging store 828, or a social networking site 830. The web content utilization functionality described herein may use any of these types of systems or the like for enabling data utilization, as described herein. A server 135 may provide output of the web content and associated functionality to clients. As one example, the server 135 may be a web server providing the web content and associated functionality over the web. The server 835 may provide the output of the web content and associated functionality over the web to clients through a network 130. By way of example, the client computing device may be implemented and embodied in a personal computer 600, a tablet computing device 105 and/or a mobile computing device (e.g., a smart phone), or other computing device. Any of these embodiments of the client computing device 600, 105 may obtain content from the store 816.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A computer implemented method of associating web content with an electronic document; comprising:
receiving a selection of a web content object from a web page;
receiving a command for inserting the web content object into an electronic document;
inserting the web content object into the electronic document; and
preserving in the inserted web content object any layout that was present in the web content object in the web page.

2. The method of claim 1, wherein preserving in the inserted web content object any layout that was present in the web content object in the web page includes preserving one or more of text font, text size, text location, text structure, color applied to any portion of the web content object; image size, image location, functional object size, and functional object location.

3. The method of claim 1,
wherein the web content object includes one or more functional components; and
further comprising preserving in the inserted web content object the one or more functional components wherein any function of the one or more functional components is enabled in the inserted web content object.

4. The method of claim 3, wherein preserving in the inserted web content object the one or more functional components wherein any function of the one or more functional components is enabled in the inserted web content object includes preserving in the inserted web content object one or more selectable links, wherein selection of one of the one or more selectable links in the inserted web content object causes a navigation to a web page associated with a selected link.

5. The method of claim 3, wherein preserving in the inserted web content object the one or more functional components wherein any function of the one or more functional components is enabled in the inserted web content object includes preserving in the inserted web content object a video presentation object, wherein selection of the video presentation object enables a playing of a video file via the video presentation object in the inserted web content object.

6. The method of claim 3, wherein preserving in the inserted web content object the one or more functional components wherein any function of the one or more functional components is enabled in the inserted web content object includes preserving in the inserted web content object an audio presentation object, wherein selection of the audio presentation object enables a playing of an audio file via the audio presentation object in the inserted web content object.

7. The method of claim 1, further comprising:
in response to receiving a command to change a size of the inserted web content object, changing the size of the inserted web content object in the electronic document; and
preserving in the changed size inserted web content object any layout that was present in the web content object in the web page.

8. The method of claim 1, further comprising in response to receiving a command to move the inserted web content object in the electronic document from a first location to a second location, moving the inserted web content object in the electronic document from a first location to a second location.

9. The method of claim 8, wherein after moving the inserted web content object in the electronic document from a first location to a second location, preserving in the inserted web content object any layout associated with the inserted web content object in the first location and an operability of any functional components contained in the web content object in the first location.

10. The method of claim 1, further comprising enabling a scrolling of content contained in the inserted web content object in the electronic document.

11. The method of claim 1, wherein one or more functions of an application program with which the electronic document is enabled may be used in association with the inserted web content object.

12. The method of claim 1, further comprising:
receiving a search term via a search function of an application program with which the electronic document is enabled;
searching for the search term in content contained in the inserted web content object; and
displaying any terms located in the inserted web page content matching the search term.

13. The method of claim 1, further comprising in response to receiving a command to annotate a portion of the inserted web content object with one or more annotations, annotating the portion of the inserted web content object.

14. The method of claim 13, wherein annotating the portion of the inserted web content object includes annotating the portion of the inserted web content object with electronic ink via an inking gesture.

15. The method of claim 13, wherein annotating the portion of the inserted web content object includes annotating the portion of the inserted web content object with electronic highlighting via an inking gesture.

16. The method of claim 1, wherein if any programming scripts operate in the selected web content object, operating the programming scripts in the inserted web content object in the electronic document.

17. A system for associating web content with an electronic document, comprising:
one or more processors; and
a memory coupled to the one or more processors, the one or more processors operable to:
receive a selection of a web content object from a web page;
receive a command for inserting the web content object into an electronic document;
paste the web content object into the electronic document;
preserve in the inserted web content object any layout that was present in the web content object in the web page; and
preserve in the inserted web content object the one or more functional components wherein any function of the one or more functional components is enabled in the inserted web content object.

18. The system of claim 17, being further operable to enable one or more functions of an application program with which the electronic document is displayed for use in association with the inserted web content object.

19. A computer readable medium on which is stored computer executable instructions which when executed by a computer perform a method of associating web content with an electronic document; comprising:
receiving a selection of a web content object from a web page;
receiving a command for inserting the web content object into an electronic document;
inserting the web content object into the electronic document;
preserving in the inserted web content object any layout that was present in the web content object in the web page; and
wherein if any programming scripts operate in the selected web content object in the web page, operating the programming scripts in the inserted web content object in the electronic document.

20. The method of claim 19,
wherein the web content object includes one or more functional components; and
further comprising preserving in the inserted web content object the one or more functional components wherein any function of the one or more functional components is enabled in the inserted web content object.
